(19) United States
(12) Patent Application Publication
(10) Pub. No.: US 2025/0167392 A1
(43) Pub. Date: May 22, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Gyeonggi-do (KR)

(72) Inventor: Sam-Jin PARK, Gyeonggi-do (KR)

(73) Assignee: SAMSUNG SDI CO., LTD., Gyeonggi-do (KR)

(21) Appl. No.: 18/792,834

(22) Filed: Aug. 2, 2024

(30) Foreign Application Priority Data
Nov. 16, 2023 (KR) 10-2023-0159407

(51) Int. Cl. H01M 50/42; H01M 4/02; H01M 4/36; H01M 4/38; H01M 4/525; H01M 4/583; H01M 10/052; H01M 10/0585; H01M 50/417; H01M 50/434; H01M 50/443; H01M 50/491

(52) U.S. Cl. CPC H01M 50/42; H01M 4/362; H01M 4/386; H01M 4/525; H01M 4/583; H01M 10/052; H01M 10/0585; H01M 50/417; H01M 50/434; H01M 50/443; H01M 50/491; H01M 2004/027; H01M 2004/028

(57) ABSTRACT

Examples of the disclosure relate to a separator for a rechargeable lithium battery and a rechargeable lithium battery including the same. In examples, a rechargeable lithium battery includes a positive electrode including a positive electrode active material having a nickel content among a transition metal that is greater than or equal to about 90 mol %; a negative electrode; and a separator between the positive electrode and the negative electrode. The separator includes a substrate and a heat resistant adhesive layer on at least one surface of the substrate. The heat resistant adhesive layer includes inorganic particles, a heat resistant binder, and a swellable adhesive binder, and the swellable adhesive binder includes a first structural unit derived from a vinyl aromatic monomer; a second structural unit derived from an alkyl acrylate; and a third structural unit derived from a phosphonate-based monomer.

### CROSS-REFERENCE TO RELATED APPLICATION

This application claims priority to and the benefit of Korean Patent Application No. 10-2023-0159407 filed in the Korean Intellectual Property Office on Nov. 16, 2023, the entire contents of which are incorporated herein by reference.

### BACKGROUND OF THE INVENTION

### (a) Field of the Invention

Examples of the disclosure relate to separators for a rechargeable lithium battery and rechargeable lithium batteries including the same.

### (b) Description of the Related Art

Recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery includes a positive electrode and a negative electrode including an active material capable of intercalating and deintercalating lithium ions, and an electrolyte solution. Electrical energy is produced through oxidation and reduction reactions when lithium ions are intercalated/deintercalated from the positive electrode and the negative electrode.

Additionally, in order to hinder or substantially prevent short circuits between the positive and negative electrodes of rechargeable lithium batteries, olefin-based substrates are typically used as separators. The olefin-based substrate has the advantage of substantial flexibility, but has a disadvantage of rapid heat shrinkage at high temperatures.

However, as the capacity and/or output of a rechargeable lithium battery increases, the amount of heat that is generated during charging and discharging typically increases. As a result, strengthening the heat resistance of the separator may be advantageous. Meanwhile, when a rechargeable lithium battery is stored and/or charged and discharged at high temperature, an adhesive strength between the separator and the electrode is likely to weaken. As a result, strengthening the adhesive strength between the separator and the electrode may also be advantageous.

### SUMMARY OF THE INVENTION

Example embodiments of the disclosure provide a high-capacity/high-output rechargeable lithium battery using a separator that simultaneously or contemporaneously ensures heat resistance and adhesive strength.

Other example embodiments provide a rechargeable lithium battery having a positive electrode that includes a positive electrode active material having a nickel content among a transition metal of greater than or equal to about 90 mol %; a negative electrode; and a separator between the positive electrode and the negative electrode. The separator may include a substrate; and a heat resistant adhesive layer on at least one surface of the substrate, the heat resistant adhesive layer including inorganic particles, a heat resistant binder, and a swellable adhesive binder, The swellable adhesive binder may include a first structural unit derived from or including a vinyl aromatic monomer; a second structural unit derived from or including an alkyl acrylate; and a third structural unit derived from or including a phosphonate-based monomer.

As a result of applying a separator that simultaneously or contemporaneously secures heat resistance and adhesive strength, the rechargeable lithium battery according to some example embodiments has high-capacity/high-output characteristics while ensuring high-temperature safety.

### BRIEF DESCRIPTION OF THE DRAWINGS

FIG. 1 is an exploded perspective view of a rechargeable lithium battery according to some example embodiments.

### DETAILED DESCRIPTION OF THE EMBODIMENTS

Hereinafter, example embodiments will be described in detail. However, these embodiments are examples, the present disclosure is not limited thereto and is defined by the scope of claims.

As used herein, when a specific definition is not otherwise provided, it will be understood that when an element such as a layer, film, region, or substrate is referred to as being “on” another element, it can be directly on the other element or intervening elements may also be present.

As used herein, when a specific definition is not otherwise provided, the singular may also include the plural. In addition, unless otherwise specified, “A or B” may mean “including A, including B, or including A and B.”

As used herein, “combination thereof” may mean a mixture of constituents, a stack, a composite, a copolymer, an alloy, a blend, and a reaction product.

As used herein, when a definition is not otherwise provided, a particle size may be an average particle size. This average particle size means an average particle size (D50), which is a diameter of particles with a cumulative volume of 50 volume % in the particle size distribution. The average particle size (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle size (D50) value may be easily obtained through a calculation. A laser diffraction method may also be used. When measuring by laser diffraction, for example, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

As used herein, when a specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C7 to C20 arylalkyl group, “alkylene group” refers to a C1 to C20 alkylene group, “arylene group” refers to a C6 to C20 arylene group, “alkylarylene group” refers to a C7 to C20 alkylarylene group, “heteroarylene group” refers to a C3 to C20 heteroarylene group, and “alkoxylene group” refers to a C1 to C20 alkoxylene group.

As used herein, when a specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amino group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when a specific definition is not otherwise provided, “hetero” refers to inclusion of at least one heteroatom of N, O, S, and P in chemical formulas.

As used herein, when a specific definition is not otherwise provided, “(meth)acrylate” refers to both “acrylate” and “methacrylate,” and “(meth)acrylic acid” refers to “acrylic acid” and “methacrylic acid,” and “(meth)acrylamidosulfonic acid” refers to both “acrylamidosulfonic acid” and “methacrylamidosulfonic acid.”

In chemical formulas of the present disclosure, unless a specific definition is otherwise provided, hydrogen is bonded at the position when a chemical bond is not drawn where supposed to be given.

As used herein, a weight average molecular weight (Mw) may be a value measured using gel permeation chromatography (GPC).

When the terms “about” and “substantially” are used in this disclosure in connection with a numerical value, it is intended that the associated numerical value include a tolerance of ±10% around the stated numerical value. Moreover, when reference is made to percentages in this specification, it is intended that those percentages are based on weight, e.g., weight percentages. When ranges are specified, the range includes all values therebetween such as increments of 0.1%.

### (Rechargeable Lithium Battery)

As rechargeable lithium batteries increase in capacity and/or output, an amount of heat generated during charging and discharging typically increases, and thus strengthening the heat resistance of the separator may be advantageous.

On the other hand, when the rechargeable lithium batteries are stored and/or charged and discharged at a high temperature, adhesive strength between separator and positive electrode is typically weakened by gas generated at the positive electrode. In addition, the gas generated at the positive electrode typically precipitates a lithium salt on the surface of the negative electrode, by which adhesive strength between separator and negative electrode may weaken. As a result, the efficiency of the rechargeable lithium batteries may be deteriorated, but the resistance thereof may be increased.

Furthermore, in the case of rechargeable lithium batteries using a positive electrode active material (so-called, a high nickel-based positive electrode active material) having a nickel content that is greater than or equal to about 90 mol % among a transition metal to secure high capacity and/or high power, because the heat generated therefrom is increased during the charging and discharging, strengthening the heat resistance of the separator, may be advantageous. On the other hand, when the rechargeable lithium batteries are stored and/or charged and discharged at a high temperature, because the adhesive strength between the separator and the electrodes may be weakened, it may be advantageous to strengthen the adhesive strength of the separator and the electrodes.

Example embodiments provide a rechargeable lithium battery having a positive electrode that includes a positive electrode active material having a nickel content among a transition metal of greater than or equal to about 90 mol %, a negative electrode, and a separator between the positive electrode and the negative electrode. The separator may include a substrate and a heat resistant adhesive layer on at least one surface of the substrate, the heat resistant adhesive layer including inorganic particles, a heat resistant binder, and a swellable adhesive binder. The swellable adhesive binder includes a first structural unit derived from or including a vinyl aromatic monomer, a second structural unit derived from or including an alkyl acrylate, and a third structural unit derived from or including a phosphonate-based monomer.

The rechargeable lithium battery according to some example embodiments, to which a separator simultaneously or contemporaneously securing heat resistance and adhesive strength is applied, may exhibit high-capacity/high-output characteristics by including a positive electrode active material having a nickel content of greater than or equal to about 90 mol % among a transition metal content, and may also secure high-temperature safety.

Hereinafter, the rechargeable lithium battery according to some example embodiments may be illustrated in more details.

### Physical Properties of Separator

A separator according to some example embodiments includes the heat resistant adhesive layer and thereby, may exhibit the following properties.

The separator according to some example embodiments, after being passed through a process under low-temperature and low-pressure conditions, may exhibit a wet adhesive strength between separator and electrodes that may be greater than or equal to about 0.05 gf/mm, or greater than or equal to about 0.1 gf/mm.

The separator according to some example embodiments may have a dry shrinkage rate of less than or equal to about 5%, less than or equal to about 4%, less than or equal to about 3%, or less than or equal to about 2.5% at a temperature of about 150° C.

A separator securing the above properties may improve high-temperature charge and discharge and/or storage characteristics of a rechargeable lithium battery.

### Heat Resistant Adhesive Layer

The heat resistant adhesive layer according to example embodiments includes inorganic particles, a heat resistant binder, and a swellable adhesive binder.

Because the heat resistant binder is a binder having improved heat resistance, and the swellable adhesive binder is a binder having improved heat resistance and adhesive strength, the heat resistant adhesive layer as a single layer may harmoniously achieve heat resistance and adhesive strength.

### Swellable Adhesive Binder

Generally known binders typically mostly or only exhibit wet adhesive strength under high-temperature and high-pressure conditions.

However, prismatic rechargeable lithium batteries are manufactured by inserting a jelly roll in which a stack of positive electrode/separator/negative electrode is wound into a prismatic can, and then injecting an electrolyte solution. However, and high-temperature and high-pressure conditions may not be applied during and/or after the manufacturing process. Accordingly, when commonly known binders are applied to prismatic rechargeable lithium batteries, wet adhesive strength may not be achieved.

This phenomenon is accelerated in the case of applying a high nickel-based positive electrode active material to a rechargeable lithium battery to achieve high capacity/high power.

On the other hand and according to example embodiments, the swellable adhesive binder includes a first structural unit derived from or including a vinyl aromatic monomer; a second structural unit derived from or including an alkyl acrylate; and a third structural unit derived from or including a phosphonate-based monomer, so that wet adhesive strength may be achieved even under low-temperature and low-pressure conditions.

Accordingly, the separator according to some example embodiments can ensure wet adhesive strength even under low-temperature and low-pressure conditions during the manufacturing process (for example, formation process) of a prismatic rechargeable lithium battery.

In various examples, the first structural unit derived from or including the vinyl aromatic monomer may be represented by Chemical Formula 1.

In various examples, the second structural unit derived from or including the alkyl acrylate may be represented by Chemical Formula 2.

In various examples, the third structural unit derived from or including the phosphonate-based monomer may be represented by Chemical Formula 3.

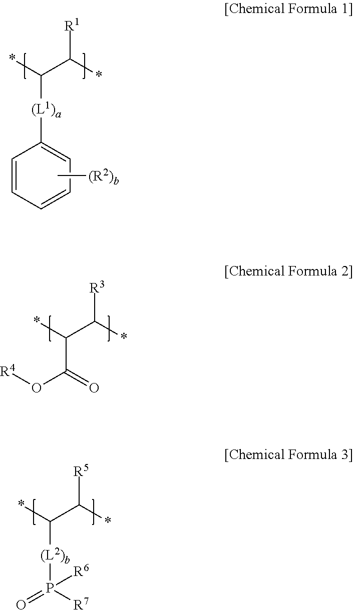

The descriptions of Chemical Formulas 1 to 3 are as follows:

R¹, R³, and R⁵ may each independently be a hydrogen or a C1 to C6 alkyl group. As an example, R¹ may be hydrogen, R³ may be a methyl group, and R⁵ may be a hydrogen or a methyl group.

R² may be fluorine, a substituted or unsubstituted C1 to C6 alkyl group, a substituted or unsubstituted C6 to C20 aryl group, or a substituted or unsubstituted C1 to C6 alkenyl group.

R⁴ may be a substituted or unsubstituted C1 to C20 alkyl group. As an example, R⁴ may be a 2-ethylhexyl group.

L¹ may be a substituted or unsubstituted C1 to C6 alkylene group, a substituted or unsubstituted C3 to C10 cycloalkylene group, a substituted or unsubstituted C6 to C20 arylene group, or a combination thereof.

L² may be a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof. For example, L² may be a carboxyl group (—C(═O)O—).

R⁶ and R⁷ may each independently be a substituted or unsubstituted C1 to C10 alkoxy group, or a substituted or unsubstituted C6 to C20 aryloxy group. For example, R⁶ and R⁷ may all be a methoxy group.

In the formulas above, “a” and “c” may each independently be integers from 0 to 2, “b” may be integers from 0 to 5. As an example, “a” may be equal to 0, “b” may be equal to 0, and “c” may be equal to 1.

Based on 100 wt % of the shell of the swellable adhesive binder, the first structural unit may be included in an amount that is greater than or equal to about 40 wt % and less than or equal to about 90 wt %, or in an amount that is about 50 wt % to about 80 wt %; the second structural unit may be included in an amount that is about 5 wt % to about 40 wt %, or in an amount that is about 10 wt % to about 30 wt %; and the third structural unit may be included in an amount that is about 0.1 wt % to about 20 wt %, or in an amount that is about 5 wt % to about 20 wt %.

The swellable adhesive binder may be in the form of a particle and can maintain a particle form without dissolving in an aqueous solvent.

For example, the swellable adhesive binder may be a particle of a core-shell structure, in which case it is advantageous to ensure an appropriate average particle size and a degree of swelling. Components of the core are not particularly limited and may be or include, for example, an acrylic polymer, a diene polymer, or a copolymer thereof. The shell may include a first structural unit derived from or including a vinyl aromatic monomer; a second structural unit derived from or including an alkyl acrylate; and a third structural unit derived from or including a phosphonate-based monomer.

For example, a D50 particle size of the swellable adhesive binder may be about 0.1 μm to about 1 μm, about 0.2 μm to about 0.9 μm, about 0.2 μm to about 0.8 μm, or about 0.2 μm to about 0.7 μm. Within any of the above-listed ranges, the heat resistant adhesive layer can achieve improved adhesive strength even at a low thickness without deteriorating the heat resistance of the separator.

A glass transition temperature of the swellable adhesive binder may be about 60° C. to about 120° C., about 60° C. to about 90° C., or about 60° C. to about 75° C. Within any of the above-listed ranges, the swellable adhesive binder is advantageous for exhibiting wet adhesive strength even under low-temperature and low-pressure conditions, and the heat resistant adhesive layer can realize improved adhesive strength even at a low thickness without deteriorating the heat resistance of the separator.

After being left in an electrolyte solution at 60° C. for 72 hours, the swellable adhesive binder may expand about 2 to about 1,000 times, about 3 to about 1,000 times, or about 6 to about 1,000 times an initial volume thereof. Within any of the above-listed ranges, the swellable adhesive binder is advantageous for exhibiting wet adhesive strength even under low-temperature and low-pressure conditions, and the heat resistant adhesive layer can realize improved adhesive strength even with a low thickness without reducing the heat resistance and air permeability of the separator.

The example electrolyte solution composition follows the examples.

An average molecular weight of the swellable adhesive binder may be about 100,000 g/mol to about 800,000 g/mol, or about 300,000 g/mol to about 500,000 g/mol as measured by the GPC method.

In the heat resistant adhesive layer, a loading amount of the swellable adhesive binder may be about 0.05 to about 1 g/m².

### Heat Resistant Binder

The heat resistant binder may be a first heat resistant binder, a second heat resistant binder, or a combination thereof.

The first heat resistant binder may include a fourth structural unit derived from or including (meth)acrylic acid or (meth)acrylate; a fifth cyano group-containing structural unit; and a sixth sulfonate group-containing structural unit.

The fourth structural unit derived from or including (meth)acrylic acid or (meth)acrylate may be represented by any one of Chemical Formula 11, Chemical Formula 12, Chemical Formula 13, and a combination thereof.

The fifth cyano group-containing structural unit may be represented by or include Chemical Formula 14.

The sixth sulfonate group-containing structural unit may be represented by or include any one of Chemical Formula 15, Chemical Formula 16, Chemical Formula 17, and a combination thereof.

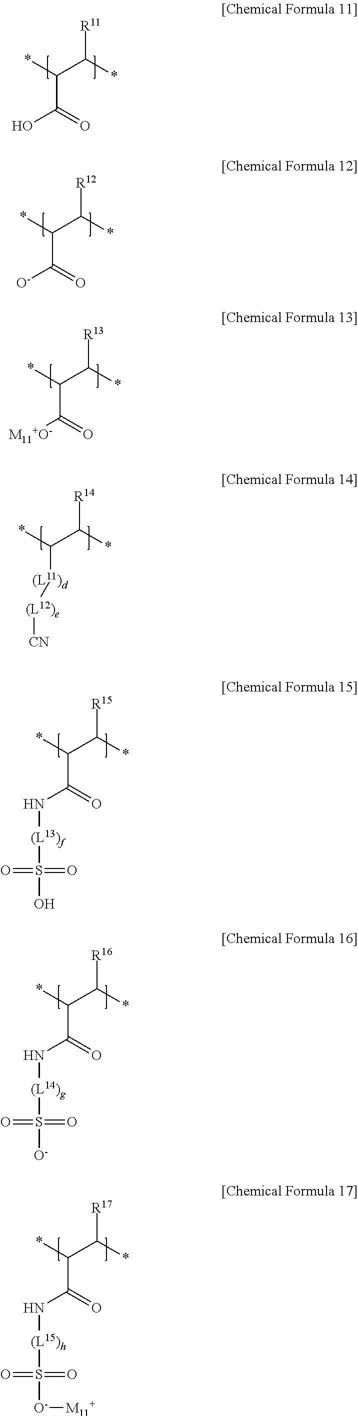

The descriptions of Chemical Formulas 11 to 17 are as follows:

R¹¹ to R¹⁷ may each independently be hydrogen or a C1 to C6 alkyl group. As an example, R¹¹ to R¹⁷ may all be hydrogen.

L¹¹ and L¹² may each independently be a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹¹ and L¹² may all be a single bond.

L¹³ to L¹⁵ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹³ to L¹⁵ may all be *—C(CH₃)₂—CH₂—*.

M₁₁ may be an alkali metal. The alkali metal may be lithium, sodium, potassium, rubidium, or cesium, and for example, may be lithium or sodium.

d, e, f, g, and h may each independently be integers from 0 to 2. For example, d, e, f, g, and h may all be equal to 1.

The fourth structural unit derived from or including (meth)acrylic acid or (meth)acrylate may include, respectively or together, the structural unit represented by Chemical Formula 11 and the structural unit represented by Chemical Formula 13. In the latter case, the structural unit derived from or including (meth)acrylic acid or (meth)acrylate may include the structural unit represented by Chemical Formula 11 and the structural unit represented by Chemical Formula 13 in a molar ratio of about 1:10 to about 2:1, about 1:5 to about 1:1, or about 1:3 to about 1:1.

The sixth sulfonate group-containing structural unit may include, respectively or together, the structural unit represented by Chemical Formula 15 and the structural unit represented by Chemical Formula 17. In the latter case, the sixth sulfonate group-containing structural unit may include the structural unit represented by Chemical Formula 15 and a structural unit represented by Chemical Formula 17 in a molar ratio of about 1:10 to about 2:1, about 1:5 to about 1:1, or about 1:3 to about 1:1.

Based on 100 mol % of the first heat resistant binder, the fourth structural unit may be included in an amount of greater than or equal to about 10 mol % to less than or equal to about 70 mol %, greater than or equal to about 30 mol % to less than or equal to about 60 mol %, or greater than or equal to about 40 mol % to less than or equal to about 50 mol %; the fifth structural unit may be included in an amount of greater than or equal to about 30 mol % to less than or equal to about 85 mol %, greater than or equal to about 40 mol % to less than or equal to about 70 mol %, or greater than or equal to about 45 mol % to less than or equal to about 55 mol %; and the sixth structural unit may be included in an amount of greater than or equal to about 0.1 mol % to less than or equal to about 20 mol %, greater than or equal to about 0.5 mol % to less than or equal to about 15 mol %, or greater than or equal to about 1 mol % to less than or equal to about 10 mol %.

Examples of the first heat resistant binder are as follows:

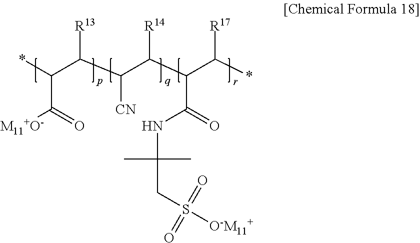

The descriptions of Chemical Formula 18 are as follows.

R¹³, R¹⁴, and R¹⁷ may each independently be hydrogen or a C1 to C6 alkyl group. For example, R¹³, R¹⁴, and R¹⁷ may all be hydrogen.

M₁₁ may be alkali metal. The alkali metal may be lithium, sodium, potassium, rubidium, or cesium, for example lithium or sodium.

The p, q, and r mean a molar ratio of each unit, and may be 0.1≤p≤0.7, 0.3≤m≤0.85, and 0.001≤n≤0.2. In an examples, p, q, and r may be 0.3≤p≤0.6, 0.4≤q≤0.7, and 0.005≤r≤0.15. In another examples, p, q, and r may be 0.4≤p≤0.5, 0.45≤q≤0.55, and 0.01≤r≤0.1.

The first heat resistant binder represented by the Chemical Formula 18 may be poly(acrylic acid-co-acrylonitrile-co-lithium 2-acrylamido-2-methylpropanesulfonate salt).

The first heat resistant binder may be prepared by various known methods such as emulsion polymerization, suspension polymerization, massive polymerization, solution polymerization, or bulk polymerization.

The first adhesive binder may have a weight average molecular weight (Mw) of about 200,000 to about 7,000,000 g/mol as measured by GPC method.

The second heat resistant binder may include a seventh structural unit including at least one of a structural unit derived from or including (meth)acrylic acid or (meth)acrylate and a structural unit derived from or including (meth)acrylamide; and an eighth structural unit derived from or including (meth)acrylamidosulfonic acid or a salt thereof.

The structural unit derived from or including the (meth)acrylic acid or (meth)acrylate may be represented by or include any one of Chemical Formula 101, Chemical Formula 102, Chemical Formula 103, and a combination thereof.

The structural unit derived from or including the (meth)acrylamide may be represented by or include Chemical Formula 104.

The eighth structural unit derived from or including the (meth)acrylamidosulfonic acid or the salt thereof may be represented by or include any one of Chemical Formula 105, Chemical Formula 106, Chemical Formula 107, and a combination thereof.

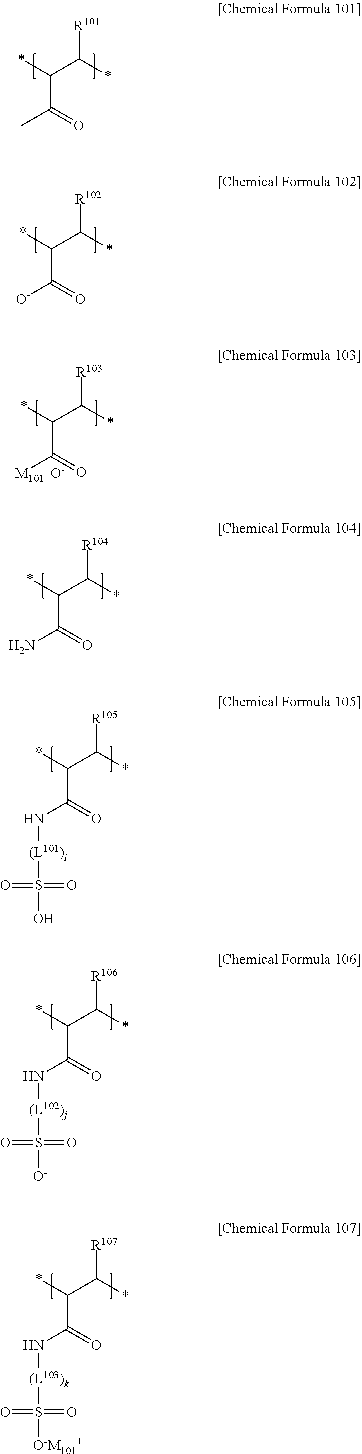

The descriptions of Chemical Formulas 101 to 107 are as follows:

R¹⁰¹ to R¹⁰⁷ may each independently be hydrogen or a C1 to C6 alkyl group. As an example, R¹⁰¹ to R¹⁰⁷ may all be hydrogen.

L¹⁰¹ to L¹⁰³ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹⁰¹ to L¹⁰³ may all be *—C(CH₃)₂—CH₂—*.

M₁₀₁ may be an alkali metal. The alkali metal may be lithium, sodium, potassium, rubidium, or cesium, for example lithium or sodium.

i, j, and k may each independently be integers from 0 to 2. As an example, i, j, and k may all be equal to 1.

The structural unit derived from or including (meth)acrylic acid or (meth)acrylate may include, respectively, or together, the structural unit represented by Chemical Formula 101 and the structural unit represented by Chemical Formula 103. In the latter case, the structural unit derived from the (meth)acrylic acid or (meth)acrylate may include the structural unit represented by Chemical Formula 101 and the structural unit represented by Chemical Formula 103 in a molar ratio of about 1:10 to about 2:1, about 1:5 to about 1:1, or about 1:3 to about 1:1.

The eighth structural unit derived from or including the (meth)acrylamidosulfonic acid or the salt thereof may include respectively, or together, the structural unit represented by Chemical Formula 105 and the structural unit represented by Chemical Formula 107. In the latter case, the structural unit derived from or including (meth)acrylamidosulfonic acid or the salt thereof may include the structural unit represented by Chemical Formula 105 and the structural unit represented by Chemical Formula 107 in a molar ratio of about 1:10 to about 2:1, about 1:5 to about 1:1, or about 1:3 to about 1:1.

Based on 100 mol % of the second heat resistant binder, the seventh structural unit may be included in an amount of greater than or equal to about 50 mol % and less than about 100 mol % or greater than or equal to about 55 mol % and less than about 100 mol %; and the eighth structural unit may be included in an amount of greater than about 0 mol % and less than or equal to about 50 mol %, or greater than about 0 mol % and less than or equal to about 45 mol %.

Examples of the second heat resistant binder are as follows:

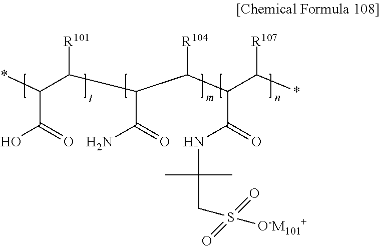

The descriptions of Chemical Formulas 108 is as follows.

R¹⁰¹, R¹⁰⁴, and R¹⁰⁷ may each independently be hydrogen or a C1 to C6 alkyl group. As an example, R¹⁰¹, R¹⁰⁴, and R¹⁰⁷ may all be hydrogen.

M₁₀₁ may be an alkali metal. The alkali metal may be lithium, sodium, potassium, rubidium, or cesium, for example lithium or sodium.

l, m, and n mean a molar ratio of each unit, and l+m+n=1. Herein, 0.5≤(l+m)<1 and 0<n≤0.5, or 0.55≤(l+m)<1 and 0<n≤0.45.

Desirably, they may be 00≤l≤0.4, 0.55≤m≤0.95, and 0≤n≤0.1. More desirably, they may be 0≤l≤0.2, 0.8≤m≤0.95, and 0<n≤0.1.

The second heat resistant binder represented by Chemical Formula 108 may be or include poly(acrylic acid-co-acrylamide-co-lithium 2-acrylamido-2-methylpropanesulfonate salt).

The second heat resistant binder may be prepared by various known methods such as emulsion polymerization, suspension polymerization, bulk polymerization, solution polymerization, or bulk polymerization.

The second heat resistant binder may have a weight average molecular weight of about 350,000 g/mol to about 970,000 g/mol as measured by GPC method.

### Inorganic Particles

The inorganic particles can reduce the possibility of a short circuit between the positive electrode and the negative electrode and hinder or substantially prevent the separator from rapidly shrinking or deforming due to a rise in temperature. That is, the heat resistant adhesive layer can improve the heat resistance and safety of the battery by including inorganic particles.

The inorganic particles may be or include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or any combination thereof.

For example, the inorganic particle may be boehmite, which may facilitate the control of the D50 particle size and shape.

The D50 particle size of the inorganic particles may be about 0.1 μm to about 10 μm, about 0.1 μm to about 5 μm, or about 0.1 μm to about 1 μm.

When the inorganic particles are plate-shaped or fibrous, an aspect ratio of the inorganic particles may be about 1:5 to about 1:100, for example, about 1:10 to about 1:100, or about 1:10 to about 1:100, or about 1:10 to about 1:50. Additionally, a ratio of the length of the major axis to the minor axis on the flat surface of the plate-shaped inorganic particle may be about 1 to 3 or about 1 to 2. The aspect ratio and the ratio of the length of the major axis to the minor axis may be measured using an optical microscope. When the aspect ratio and the length range of the minor axis to the major axis are satisfied, a heat shrinkage rate of the separator can be lowered, relatively improved porosity can be ensured, and the physical stability of the lithium battery can be improved.

### Composition of Heat Resistant Adhesive Layer

A weight ratio of the swellable adhesive binder to the inorganic particles in the heat resistant adhesive layer may be about 1:3 to about 1:30, about 1:4 to about 1:25, or about 1:5 to about 1:20. However, the content of the swellable adhesive binder in the heat resistant adhesive layer may be higher on the negative electrode side than on the positive electrode side.

A weight ratio of the heat resistant binder and the swellable adhesive binder in the heat resistant adhesive layer may be about 1:1 to about 1:10, about 1:1 to about 1:5, or about 1:1 to about 1:3. Within this range, the heat resistance and adhesive strength of the separator according to some embodiments can be exhibited in harmony.

### Thickness of Heat Resistant Adhesive Layer

In various examples, the thickness of the heat resistant adhesive layer is not particularly limited, but may be 5 length % to 45 length %, or 10 length % to 30 length % of the thickness of the substrate, based on the thickness of the heat resistant adhesive layer formed on one surface of the porous substrate.

For example, a thickness of the heat resistant adhesive layer may be about 0.1 μm to about 5 μm, or about 0.1 μm to about 3 μm.

### Single-Surface Coating or Double-Surface Coating

In various examples, the heat resistant adhesive layer may be disposed on one surface of the substrate (single-surface coating) or on both surfaces (double-surface coating).

When the heat resistant adhesive layer is coated on both surfaces, it may be advantageous to simultaneously or contemporaneously secure the heat resistance and adhesive strength of the separator compared to when the heat resistant adhesive layer is coated on only one surface. Additionally, when the heat resistant adhesive layer is coated on both surfaces, a loading amount of the swellable adhesive binder in contact with the negative electrode may be higher than a loading amount of the swellable adhesive binder in contact with the positive electrode.

### Substrate

In various examples, the substrate may be a porous substrate.

The porous substrate may be a polymer film formed of or include any one of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

For example, the porous substrate may be a polyolefin-based substrate containing polyolefin, and the polyolefin-based substrate may have an improved shutdown properties, which can contribute to improving the safety of the battery. The polyolefin-based substrate may be selected from, for example, a polyethylene single film, a polypropylene single film, a polyethylene/polypropylene double film, a polypropylene/polyethylene/polypropylene triple film, and a polyethylene/polypropylene/polyethylene triple film. Additionally, the polyolefin-based resin may include a non-olefin resin in addition to an olefin resin, or may include a copolymer of olefin and non-olefin monomer.

The porous substrate may have a thickness in a range of about 1 μm to about 40 μm, for example about 1 μm to about 30 μm, about 1 μm to about 20 μm, about 5 μm to about 20 μm, about 5 μm to about 15 μm, or about 5 μm to about 10 μm.

### Method of Manufacturing the Separator

The separator according to some example embodiments may be manufactured by various known methods. For example, a separator may be formed by coating a composition for forming the heat resistant adhesive layer to one or both surfaces of a porous substrate and then drying it.

The coating may be, for example spin coating, dip coating, bar coating, die coating, slit coating, roll coating, inkjet printing, and the like, but is not limited thereto.

The drying may be for example performed through natural drying, drying with warm air, hot air, or low humid air, vacuum-drying, or radiation of a far-infrared ray, an electron beam, and the like, but examples of the present disclosure are not limited thereto. The drying process may be performed at a temperature of, for example, about 25° C. to about 120° C.

The separator may be manufactured by lamination, coextrusion, and the like in addition to the aforementioned method.

### Positive Electrode Active Material

In various examples, the positive electrode active material may be or include a compound (lithiated intercalation compound) capable of intercalating and deintercalating lithium. For example, the positive electrode active material may include one or more types of composite oxides of lithium and a metal selected from cobalt, manganese, nickel, and combinations thereof.

The composite oxide may be or include a lithium transition metal composite oxide, and examples thereof may include lithium nickel-based oxide, lithium cobalt-based oxide, lithium manganese-based oxide, a lithium iron phosphate-based compound, cobalt-free lithium nickel-manganese-based oxide, or any combination thereof.

As an example, the composite oxide may include a compound represented by any of the following chemical formulas. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c} Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-b}G_{b}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above-listed chemical formulas for the composite oxide, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a lithium nickel-based oxide represented by Chemical Formula I, a lithium cobalt-based oxide represented by Chemical Formula II, a lithium iron phosphate-based compound represented by Chemical Formula III, a cobalt-free lithium nickel-manganese-based oxide represented by Chemical Formula IV, or a combination thereof.

Liₐ₁Niₓ₁M¹_{y1}M²_{z1}O_{2-b1}X_{b1} [Chemical Formula I]

In Chemical Formula 1, 0.9≤a1≤1.2, 0.9≤x1≤1, 0≤y1≤0.1, 0≤z1≤0.1, 0.9≤x1+y1+z1≤1.1, and 0≤b1≤0.1; M¹ and M² are each independently one or more elements selected from Al, B, Ba, Ca, Ce, Co, Cr, Cu, Fe, Mg, Mn, Mo, Nb, Si, Sr, Ti, V, W, and Zr; and X is one or more elements selected from F, P, and S.

Liₐ₂Coₓ₂M³_{y2}O_{2-b2}X_{b2} [Chemical Formula II]

In Chemical Formula II, 0.9≤a2≤1.2, 0.9≤x2≤1, 0≤y2≤0.1, 0.9≤x2+y2≤1.1, and 0≤b2≤0.1; M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr; and X is one or more elements selected from F, P, and S.

Liₐ₃Feₓ₃M⁴_{y3}PO_{4-b3}X_{b3} [Chemical Formula III]

In Chemical Formula III, 0.9≤a3≤1.2, 0.9≤x3≤1, 0≤y3≤0.1, and 0≤b3≤0.1; M⁴ is one or more elements selected from Al, B, Ba, Ca, Ce, Co, Cr, Cu, Mg, Mn, Mo, Ni, Se, Si, Sn, Sr, Ti, V, W, Y, Zn, and Zr; and X is one or more elements selected from F, P, and S.

Liₐ₄Niₓ₄Mn_{y4}M⁵_{z4}O_{2-b4}X_{b4} [Chemical Formula IV]

In Chemical Formula IV, 0.9≤a4≤1.2, 0.9≤x4≤1, 0≤y4≤0.1, 0≤z4≤0.1, 0.9≤x4+y4+z4≤1.1, and 0≤b4≤0.1; M⁵ is one or more elements selected from Al, B, Ba, Ca, Ce, Cr, Fe, Mg, Mo, Nb, Si, Sn, Sr, Ti, V, W, and Zr; and X is one or more elements selected from F, P, and S.

As an example, the positive electrode active material may be or include a high nickel-based positive electrode active material having a nickel content that is greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials can achieve high capacity and can be applied to a high-capacity, high-density rechargeable lithium battery.

### Positive Electrode

In various examples, the positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive configured to operate as a sacrificial positive electrode.

A content of the positive electrode active material may be about 90 wt % to about 99.5 wt %, and a content of the binder and the conductive material may be about 0.5 wt % to about 5 wt %, respectively based on 100 wt % of the positive electrode active material layer.

The binder may be configured to solidly attach the positive electrode active material particles to each other and also to solidly attach the positive electrode active material to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material including copper, nickel, aluminum, silver, etc., in a form of a metal powder or a metal fiber; a conductive polymer such as a polyphenylene derivative; or a mixture thereof.

The current collector may include Al, but is not limited thereto.

### Negative Electrode Active Material

In various examples, the negative electrode active material may be or include a material that is configured to reversibly intercalate/deintercalate lithium ions, a lithium metal, a lithium metal alloy, a material configured to dope and dedope lithium, or a transition metal oxide.

The material that is configured to reversibly intercalate/deintercalate lithium ions may include a carbon-based negative electrode active material, for example, crystalline carbon, amorphous carbon, or a combination thereof. The crystalline carbon may be graphite such as, e.g., non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material that is configured to dope/dedope lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be or include a composite of silicon and amorphous carbon. According to some example embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. In another example, the secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

At least one type of graphite or Si composite may be used as the negative electrode active material. For example, graphite can be used as the negative electrode active material.

### Negative Electrode

In various examples, a negative electrode for a rechargeable lithium battery includes a current collector and a negative electrode active material layer on the current collector. The negative electrode active material layer includes a negative electrode active material and may further include a binder and/or a conductive material.

For example, the negative electrode active material layer may include about 90 wt % to about 99 wt % of the negative electrode active material, about 0.5 wt % to about 5 wt % of the binder, or about 0.5 wt % to about 5 wt % of the conductive material.

The binder may be configured to solidly attach the negative electrode active material particles to each other and also to solidly attach the negative electrode active material to the current collector. The binder may include a non-aqueous binder, an aqueous binder, a dry binder, or any combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or any combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and any combination thereof.

When an aqueous binder is used as the negative electrode binder, it may further include a cellulose-based compound capable of imparting viscosity. The cellulose-based compound includes one or more of carboxylmethyl cellulose, hydroxypropylmethyl cellulose, methyl cellulose, or alkali metal salts thereof.

The alkali metal may be Na, K, or Li.

The dry binder may be a polymer material configured to being fiberized, and may be, for example, polytetrafluoroethylene, polyvinylidene fluoride, polyvinylidene fluoride-hexafluoropropylene copolymer, polyethylene oxide, or any combination thereof.

The conductive material may be included to provide electrode conductivity, and any electrically conductive material may be used as a conductive material unless the conductive material causes a chemical change. Examples of the conductive material may be a carbon-based material such as natural graphite, artificial graphite, carbon black, acetylene black, ketjen black, a carbon fiber, a carbon nanofiber, a carbon nanotube, and the like; a metal-based material such as copper, nickel, aluminum silver, and the like in a form of a metal powder or a metal fiber; a conductive polymer such as a polyphenylene derivative; or any mixture thereof.

The negative electrode current collector may include one of a copper foil, a nickel foil, a stainless steel foil, a titanium foil, a nickel foam, a copper foam, a polymer substrate coated with a conductive metal, and a combination thereof, but is not limited thereto.

### Electrolyte Solution

In various examples, the electrolyte solution for a rechargeable lithium battery may include a non-aqueous organic solvent and a lithium salt.

The non-aqueous organic solvent may be configured to serve as a medium for transmitting ions taking part in the electrochemical reaction of a battery.

The non-aqueous organic solvent may be or include a carbonate-based, ester-based, ether-based, ketone-based, alcohol-based solvent, aprotic solvent, or any combination thereof.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethylacetate, methylpropionate, ethylpropionate, decanolide, mevalonolactone, valerolactone (valerolactone), caprolactone, and the like. The ether-based solvent may include dibutyl ether, tetraglyme, diglyme, dimethoxyethane, 2-methyltetrahydrofuran, 2,5-dimethyltetrahydrofuran, tetrahydrofuran. The ketone-based solvent may include cyclohexanone. The alcohol-based solvent may include ethyl alcohol, isopropyl alcohol, and the like, and the aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and the like.

The non-aqueous organic solvent may be used alone or in combination of two or more.

Additionally, when using a carbonate-based solvent, cyclic carbonate and chain carbonate can be mixed and used, and cyclic carbonate and chain carbonate can be mixed at a volume ratio of about 1:1 to about 1:9.

In examples, the lithium salt dissolved in the organic solvent supplies lithium ions in a battery, enables a basic operation of a rechargeable lithium battery, and improves transportation of the lithium ions between positive and negative electrodes. Examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LIN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

### Rechargeable Lithium Battery

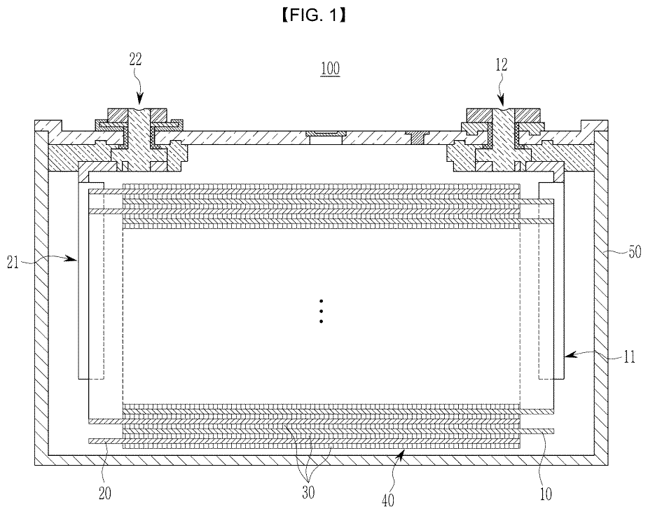

In various examples, the rechargeable lithium battery may be classified into cylindrical, prismatic, pouch, or coin-type batteries, and the like depending on their shape. FIG. 1 is a schematic view illustrating a rechargeable lithium battery according to some example embodiments and shows a prismatic battery. Referring to FIG. 1, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). In other examples, the rechargeable lithium battery 100 may include a positive electrode lead tab 11, a positive electrode terminal 12, a negative electrode lead tab 21, and a negative electrode terminal 22.

The rechargeable lithium battery may have an energy density that is greater than or equal to about 700 Wh/L, the energy density being measured under conditions of 0.3 C and 25° C.

The rechargeable lithium battery according to some example embodiments may be used in a variety of applications such as to provide electric power to automobiles, mobile phones, and/or various types of electrical devices, but examples of this disclosure are not limited thereto.

Hereinafter, examples of this disclosure and comparative examples are described. These examples, however, are not in any sense to be interpreted as limiting the scope of the invention.

### PREPARATION EXAMPLES

### Preparation Example 1

### (1) Preparation of Swellable Adhesive Binder

A swellable adhesive binder with a core-shell structure having a D50 particle size of 0.5 μm, a glass transition temperature of 65° C., a swelling degree of 8 times was prepared.

In the swellable adhesive binder, a core included a copolymer including alkylacrylate and divinylbenzene, and a shell included a copolymer of 70 wt % of styrene, 20 wt % of 2-ethylhexylmethacrylate, and 10 wt % of dimethyl[(methacryloyloxy)methyl]phsophonate.

As discussed herein, “a swelling degree” of the swellable adhesive binder refers to a swelling degree after being left in an electrolyte solution at 60° C. for 72 hours relative to an initial volume, wherein the electrolyte solution was a mixed solution of ethyl carbonate (EC)/ethylmethyl carbonate (EMC)/diethyl carbonate (DEC) (in a volume ratio of 3/5/2) including LiPF₆ at a concentration of 1.3 M. Hereinafter, the definition of “the swelling degree” of the swellable adhesive binder is the same as above.

### (2) Preparation of Heat Resistant Binder

The first heat resistant binder, the second heat resistant binder, or a combination thereof may be used as a heat resistant binder, but herein, the second heat resistant binder was used.

A method of manufacturing the second heat resistant binder is as follows.

In a 10 L four-necked flask equipped with a stirrer, a thermometer, and a cooling tube, after adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and 5 N lithium hydroxide aqueous solution (1.05 equivalents based on a total amount of 2-acrylamido-2-methylpropanesulfonic acid), the operation of reducing an internal pressure to 10 mmHg with diaphragm pump and returning the internal pressure to normal pressure with nitrogen, was repeated three times.

While controlling the temperature of reaction solution so as to be stable between 65° C. to 70° C. stable, the reaction was conducted for 12 hours. After cooling to room temperature, the pH of the reaction solution was adjusted to 7 to 8 using a 25% aqueous ammonia solution.

The poly(acrylic acid-co-acrylamide-co-lithium 2-acrylamido-2-methylpropanesulfonate salt) was prepared as discussed herein. Herein, a molar ratio of the structural unit derived from acrylic acid, the structural unit derived from acrylamide, and the structural unit derived from 2-acrylamido-2-methylpropanesulfonic acid was 10:85:5. About 10 mL of the reaction solution (reaction product) was taken and the measurement result of the non-volatile component was 9.5% (theoretical value: 10%).

### (3) Preparation of Composition for Forming Heat Resistant Adhesive Layer

As inorganic particles, boehmite with a particle size D50 of 0.3 μm was used. A composition for forming a heat resistant adhesive layer was prepared by mixing the swellable adhesive binder and the inorganic particles in a weight ratio of 1:20, and mixing the heat resistant binder to the swellable adhesive binder in a weight ratio of 3:7.

### Preparation Example 2

A composition for forming a heat resistant adhesive layer was prepared in the same manner as in Preparation Example 1 with the difference that the weight ratio of the swellable adhesive binder to the inorganic particles was changed to 1:16.

### Preparation Example 3

A composition for forming a heat resistant adhesive layer was prepared in the same manner as in Preparation Example 1 with the difference that the weight ratio of the swellable adhesive binder to the inorganic particles was changed to 1:13.

### Preparation Example 4

A composition for forming a heat resistant adhesive layer was prepared in the same manner as in Preparation Example 1 with the difference that the weight ratio of the swellable adhesive binder: to the inorganic particles was changed to 1:9.

### Comparative Preparation Example 1

A composition for forming a heat resistant adhesive layer was prepared in the same manner as in Preparation Example 1 with the difference that the swellable adhesive binder was not used.

### Comparative Preparation Example 2

### (1) Preparation of Swellable Adhesive Binder

A swellable adhesive binder with a core-shell structure having a D50 particle size of 0.5 μm, a glass transition temperature of 65° C., and a swelling degree of three times was prepared. In the swellable adhesive binder, a core included a copolymer of alkylacrylate and divinylbenzene, and a shell included a copolymer of 70 wt % of styrene, 20 wt % of 2-ethylhexylmethacrylate, and 10 wt % of acrylonitrile.

### (2) Preparation of Composition for Forming Heat Resistant Adhesive Layer

A composition for forming a heat resistant adhesive layer was prepared in the same manner as in Preparation Example 1 with the difference that the above swellable adhesive binder of Comparative Preparation Example 2 was used, and the weight ratio of the swellable adhesive binder to the inorganic particles was changed to 1:9.

### Comparative Preparation Example 3

A composition for forming a heat resistant adhesive layer was prepared in the same manner as in Comparative Preparation Example 2 with the difference that the weight ratio of the swellable adhesive binder to the inorganic particles was changed to 1:5.

### Comparative Preparation Example 4

### (1) Preparation of Swellable Adhesive Binder

A swellable adhesive binder with a core-shell structure having a D50 particle size of 0.5 μm, a glass transition temperature of 100° C., and a swelling degree of 5 times was prepared. In the swellable adhesive binder, a core included a copolymer of alkylacrylate and divinylbenzene, and a shell included a copolymer of 70 wt % of styrene, 20 wt % of butylacrylate, and 10 wt % of acrylonitrile.

A composition for a heat resistant adhesive layer was prepared in the same manner as in Preparation Example 1 with the difference that the swellable adhesive binder was used.

### (2) Preparation of Composition for Forming Heat Resistant Adhesive Layer

A composition for forming a heat resistant adhesive layer was prepared in the same manner as in Preparation Example 1 with the difference that the above swellable adhesive binder of Comparative Preparation Example 4 was used.

### Comparative Preparation Example 5

A composition for forming a heat resistant adhesive layer was prepared in the same manner as in Comparative Preparation Example 4 with the difference that the weight ratio of the swellable adhesive binder to the inorganic particles was changed to 1:5.

### EXAMPLES AND COMPARATIVE EXAMPLES

### Example 1

### (1) Manufacture of Separator

A heat resistant adhesive layer was formed to have a different thickness respectively on both surfaces of a substrate.

(Positive electrode side) For example, the heat resistant adhesive layer (a thickness: 2.5 μm) was formed on one surface of an 8 μm-thick polyethylene film (PE, SK Innovation Co., Ltd.) as a substrate by coating the composition for forming a heat resistant adhesive layer according to Preparation Example 1 at 20 m/min in a direct metering method and drying it at 60° C. under an absolute vapor amount (average value) of 14 g/m³.

(Negative electrode side) For example, the composition for forming a heat resistant adhesive layer according to Preparation Example 4 was coated on the other surface of the substrate to form another heat resistant adhesive layer (a thickness: 2.5 μm).

Each loading amount of the swellable adhesive binder on the surface in contact with each electrode is shown in Table 1 below. Herein, the loading amount of the swellable adhesive binder might be a value of calculating a weight of the swellable adhesive binder included per unit area of each of the heat resistant adhesive layers.

### (2) Manufacture of Rechargeable Lithium Battery Cell

A positive electrode slurry was prepared by mixing LiNi_{0.91}Co_{0.05}Al_{0.04}O₂ as a positive electrode active material, polyvinylidene fluoride (PVDF) as a binder, and carbon as a conductive agent in a weight ratio of 92:4:4 and dispersing the mixture in N-methyl-2-pyrrolidone. This slurry was coated to be 20 μm thick on an aluminum foil, dried, and pressed to manufacture a positive electrode.

A negative electrode active material slurry was prepared by mixing artificial graphite as a negative electrode active material, a styrene-butadiene rubber as a binder, and carboxylmethyl cellulose as a thickener in a weight ratio of 96:2:2, and dispersing the mixture in water. This slurry was coated to be 15 μm thick on a copper foil, dried, and pressed to make a negative electrode.

In an example, a prismatic battery cell was manufactured by interposing the aforementioned separator between the positive electrode and the negative electrode to manufacture a laminate, winding the laminate into a jelly-roll, housing the jelly-roll in a prismatic case, and injecting an electrolyte solution thereinto. Herein, the positive electrode side of the separator was in contact with the positive electrode, while the negative electrode side of the separator was in contact with the negative electrode.

The electrolyte solution was prepared by mixing ethyl carbonate (EC)/ethylmethyl carbonate (EMC)/diethyl carbonate (DEC) (in a volume ratio of 3/5/2) and dissolving LiPF₆ therein at a concentration of 1.3 M.

### Example 2

A separator and a rechargeable lithium battery cell were manufactured in the same manner as in Example 1 with the difference that the positive electrode side of the separator was formed by using the composition for forming a heat resistant adhesive layer according to Preparation Example 2.

### Example 3

A separator and a rechargeable lithium battery cell were manufactured in the same manner as in Example 1 with the difference that the negative electrode side of the separator was formed by using the composition for forming a heat resistant adhesive layer according to Preparation Example 3.

### Example 4

A separator and a rechargeable lithium battery cell were manufactured in the same manner as in Example 1 with the difference that the negative electrode side of the separator was formed by using the composition for forming a heat resistant adhesive layer according to Preparation Example 1.

### Comparative Example 1

A separator and a rechargeable lithium battery cell were manufactured in the same manner as in Example 1 with the difference that the positive and negative electrode sides of the separator were respectively formed by using the composition for forming a heat resistant adhesive layer according to Comparative Preparation Example 1.

### Comparative Example 2

A separator and a rechargeable lithium battery cell were manufactured in the same manner as in Example 1 with the difference that the positive electrode side of the separator was formed by using composition for forming a heat resistant adhesive layer according to Comparative Preparation Example 2, and the negative electrode side of the separator was formed by using the composition for forming a heat resistant adhesive layer according to Comparative Preparation Example 3.

### Comparative Example 3

A separator and a rechargeable lithium battery cell were manufactured in the same manner as in Example 1 with the difference that the positive electrode side of the separator was formed by using composition for forming a heat resistant adhesive layer according to Comparative Preparation Example 4, and the negative electrode side of the separator was formed by using the composition for forming a heat resistant adhesive layer according to Comparative Preparation Example 5.

Each of the separators of the examples and the comparative examples was summarized in Tables 1 and 2.

TABLE 1

| | Swellable adhesive binder | | | Heat resistant | |
|---|---|---|---|---|---|
| | | Loading amount | | adhesive layer | |
| | | (g/m²) | | Thickness (μm) | |
| | | Positive | Negative | Positive | Negative |
| | | electrode | electrode | electrode | electrode |
| | Composition of shell | side | side | side | side |
| Ex. 1 | SM-EHMA-phosphorus- | 0.1 | 0.25 | 2.5 | 2.5 |
| | based acryl | | | | |
| Ex. 2 | SM-EHMA- phosphorus- | 0.15 | 0.25 | 2.5 | 2.5 |
| | based acryl | | | | |
| Ex. 3 | SM-EHMA- phosphorus- | 0.1 | 0.2 | 2.5 | 2.5 |
| | based acryl | | | | |
| Ex. 4 | SM-EHMA- phosphorus- | 0.1 | 0.1 | 2.5 | 2.5 |
| | based acryl | | | | |
| Comp. | — | — | — | 2.5 | 2.5 |
| Ex. 1 | | | | | |
| Comp. | SM-EHMA-AN | 0.25 | 0.4 | 2.5 | 2.5 |
| Ex. 2 | | | | | |
| Comp. | SM-BA-AN | 0.1 | 0.4 | 2.5 | 2.5 |
| Ex. 3 | | | | | |

TABLE 2

| | | Heat resistant adhesive layer | | | |
|---|---|---|---|---|---|
| | | | | Swellable adhesive binder: | |
| | | | | inorganic particle | |
| | | Inorganic | | weight ratio | |
| | Substrate | particles | Heat resistant | Positive | Negative |
| | Thickness | D50 particle | binder | electrode | electrode |
| | (μm) | size (μm) | Type | side | side |
| Ex. 1 | 8.0 | 0.3 | second heat | 1:20 | 1:9 |
| | | | resistant binder | | |
| Ex. 2 | 8.0 | 0.3 | second heat | 1:16 | 1:9 |
| | | | resistant binder | | |
| Ex. 3 | 8.0 | 0.3 | second heat | 1:20 | 1:13 |
| | | | resistant binder | | |
| Ex. 4 | 8.0 | 0.3 | second heat | 1:20 | 1:20 |
| | | | resistant binder | | |
| Comp. | 8.0 | 0.3 | second heat | — | — |
| Ex. 1 | | | resistant binder | | |
| Comp. | 8.0 | 0.3 | second heat | 1:9 | 1:5 |
| Ex. 2 | | | resistant binder | | |
| Comp. | 8.0 | 0.3 | second heat | 1:20 | 1:5 |
| Ex. 3 | | | resistant binder | | |

### EVALUATION EXAMPLES

Each of the separators and the rechargeable lithium battery cells of the examples and the comparative examples was evaluated, and the results are shown in Tables 3 and 4.

### Evaluation Example 1: Resistance of Separator

Each of the separators of the examples and the comparative examples was manufactured and then, immediately manufactured into a 2032 coin cell, which was measured with respect to AC impedance, and the results are shown in Table 3. The 2032 coin cell is a class of battery that is coin-shaped and that has a diameter of 20 mm and a thickness of 3.2 mm.

### Evaluation Example 2: Dry Shrinkage Rate of Separator

Each of the separators of the example and the comparative examples was cut into a size of 10 cm×10 cm to prepare a sample, which was left at 150° C. in a convection oven for 1 hour and taken out therefrom to measure each length variation ratio in a machine direction (MD) and a transverse direction (TD), and the results are shown in Table 3.

### Evaluation Example 3: Evaluation of Wet Adhesive Strength of Separator (Peeling Test)

### (1) Adhesive Strength Between Separator and Positive Electrode

Each of the rechargeable lithium battery cells of the examples and the comparative examples was maintained at 40° C. under a load of 50 kg for 2 hours. After separating a separator thereof from a positive electrode by about 15 mm electrode and fixing the positive electrode to a lower grip, while fixing the separator to an upper grip, they were peeled in a direction of 180° at 100 mm/min. In an example, a force required to peel them by 40 mm was three times measured and averaged to obtain an arithmetic average value, and the results are shown in Table 3.

### (2) Adhesive Strength Between Separator and Negative Electrode

The peeling test was equally performed for the separator and the negative electrode, and the results are shown in Table 3.

TABLE 3

| | Separator | | | | |
|---|---|---|---|---|---|
| | | | | Wet adhesive strength (gf/mm) | |
| | | | | separator- | separator- |
| | Resistance | Dry shrinkage rate (%) | | positive | negative |
| | (Ω) | MD | TD | electrode | electrode |
| Ex. 1 | 0.59 | 2.0 | 2.0 | 0.15 | 0.17 |
| Ex. 2 | 0.61 | 2.5 | 2.0 | 0.20 | 0.17 |
| Ex. 3 | 0.57 | 1.7 | 1.5 | 0.15 | 0.13 |
| Ex. 4 | 0.53 | 1.5 | 1.5 | 0.15 | 0.10 |
| Comp. Ex. 1 | 0.48 | 1.3 | 1.5 | 0.02 | 0.02 |
| Comp. Ex. 2 | 0.75 | 30.0 | 25.0 | 0.28 | 0.35 |
| Comp. Ex. 3 | 0.69 | 25.0 | 20.0 | 0.15 | 0.35 |

### Evaluation Example 4: High-Temperature Cycle-Life and High-Temperature Storage Characteristics of Rechargeable Lithium Battery Cell

### (1) High-Temperature Cycle-Life Characteristics

Each of the rechargeable lithium battery cells of the examples and the comparative examples was charged to an upper limit voltage of 4.25 V at a constant current of 0.1 C and discharged to a cut-off voltage of 3.5 V at a constant current of 0.1 C at 55° C. for initial charge and discharge. In an example, the cells were 10 times repeatedly charged and discharged at 0.5 C within a voltage range of 3.5 V to 4.25 V.

After the 10 cycles, the rechargeable lithium battery cells were measured with respect to a battery temperature, which was used to calculate a degree that a temperature increased from an initial temperature thereof, and the results are shown in Table 4. In addition, efficiency was calculated according to Equation 1, and the results are shown in Table 4.

$$Efficiency = ( Discharge capacity after 10 cycles / \\ Discharge capacity after 1 cycle ) * 100 ( \% ) \qquad [ Equation 1 ]$$

### (2) High-Temperature Storage Characteristics

Each of the rechargeable lithium battery cells of the examples and the comparative examples was stored at 60° C. after the initial charge and discharge to check a period (days) that SOH (state of health) of 100% was reduced to 80%, and the results are shown in Table 4.

TABLE 4

| | Rechargeable lithium battery cell | | |
|---|---|---|---|
| | High-temperature cycle-life | | High-temperature |
| | (55° C., 10 cyc.) | | storage (60° C., |
| | Temperature change | Efficiency | SOH80%) |
| | (° C.) | (%) | Day |
| Ex. 1 | 1.5 | 99 | 360 |
| Ex. 2 | 1.8 | 99 | 370 |
| Ex. 3 | 2.0 | 98 | 400 |
| Ex. 4 | 2.5 | 98 | 400 |
| Comp. Ex. 1 | 6.0 | 94 | 240 |
| Comp. Ex. 2 | 2.5 | 96 | 120 |
| Comp. Ex. 3 | 2.7 | 95 | 120 |

### (Summary)

The rechargeable lithium battery cells according to Examples 1 to 4, compared with the rechargeable lithium battery cells of Comparative Examples 1 to 3, exhibited improved dry shrinkage rate, wet adhesive strength, high temperature cycle-life, and storage characteristics.

For example, the separators according to Examples 1 to 4 exhibited a reduced increase in resistance at room temperature and exhibited a dry shrinkage rate (both of MD/TD) of 2.5% at 150° C., and wet adhesive strength of separator-electrode of less than or equal to 0.1 gf/mm after a process under conditions of a low temperature and a low pressure.

In addition, the rechargeable lithium battery cells of Examples 1 to 4 exhibited high-temperature storage characteristics of greater than or equal to 360 days and exhibited a temperature change within 2.5° C. and efficiency of 98% during the high temperature charge and discharge (cycle-life).

In summary, the separators of the examples achieved high heat resistance and adhesion properties by one coating layer and thereby, achieved heat resistance and adhesive strength at the same time. Furthermore, the separator for a rechargeable lithium battery was included, providing a rechargeable lithium battery cell having improved high-temperature characteristics.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

<Description of Symbols>

| | |
|---|---|
| 100: | rechargeable lithium battery |
| 10: | positive electrode |
| 11: | positive electrode lead tab |
| 12: | positive terminal |
| 20: | negative electrode |
| 21: | negative electrode lead tab |
| 22: | negative terminal |
| 30: | separator |
| 40: | electrode assembly |
| 50: | case |

What is claimed is:

1. A rechargeable lithium battery, comprising:
a positive electrode including a positive electrode active material having a nickel content of a transition metal that is greater than or equal to about 90 mol %;
a negative electrode; and
a separator between the positive electrode and the negative electrode, wherein the separator includes a substrate; and
a heat resistant adhesive layer on at least one surface of the substrate, the heat resistant adhesive layer including:
inorganic particles,
a heat resistant binder, and
a swellable adhesive binder, and
the swellable adhesive binder includes
a first structural unit derived from a vinyl aromatic monomer;
a second structural unit derived from an alkyl acrylate; and
a third structural unit derived from a phosphonate-based monomer.

2. The rechargeable lithium battery as recited in claim 1, wherein in the swellable adhesive binder,
the first structural unit is represented by Chemical Formula 1,
the second structural unit is represented by Chemical Formula 2, and
the third structural unit derived is represented by Chemical Formula 3: 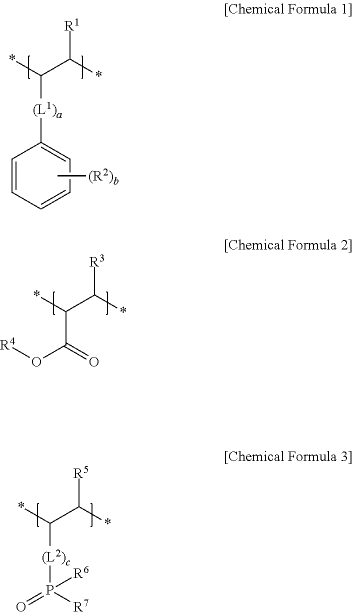
wherein, in Chemical Formulae 1 to 3,
R¹, R³, and R⁵ are each independently hydrogen or C1 to C6 alkyl group;
R² is fluorine, a substituted or unsubstituted C1 to C6 alkyl group, a substituted or unsubstituted C6 to C20 aryl group, or a substituted or unsubstituted C1 to C6 alkenyl group,
R⁴ is a substituted or unsubstituted C1 to C20 alkyl group,
L¹ is a substituted or unsubstituted C1 to C6 alkylene group, a substituted or unsubstituted C3 to C10 cycloalkylene group, a substituted or unsubstituted C6 to C20 arylene group, or a combination thereof,
L² is a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof,
R⁶ and R⁷ are each independently a substituted or unsubstituted C1 to C10 alkoxy group, or a substituted or unsubstituted C6 to C20 aryloxy group,
a and c are each independently an integer ranging from 0 to 2, and
b is an integer ranging from 0 to 5.

3. The rechargeable lithium battery as recited in claim 1, wherein:
the swellable adhesive binder includes a particle having a core-shell structure, and
the shell includes the first structural unit, the second structural unit, and the third structural unit.

4. The rechargeable lithium battery as recited in claim 1, wherein the heat resistant binder comprises at least one of a first heat resistant binder and a second heat resistant binder,
the first heat resistant binder includes:
a fourth structural unit derived from (meth)acrylic acid or (meth)acrylate;
a fifth cyano group-containing structural unit; and
a sixth sulfonate group-containing structural unit, and
the second heat resistant binder includes:
a seventh structural unit including at least one of a structural unit derived from (meth)acrylic acid or (meth)acrylate and a structural unit derived from (meth)acrylamide; and
an eighth structural unit derived from (meth)acrylamidosulfonic acid or a salt thereof.

5. The rechargeable lithium battery as recited in claim 4, wherein the fourth structural unit is represented by any one of Chemical Formula 11, Chemical Formula 12, Chemical Formula 13, and a combination thereof,
the fifth cyano group-containing structural unit is represented by Chemical Formula 14,
the sixth sulfonate group-containing structural unit is represented by any one of Chemical Formula 15, Chemical Formula 16, Chemical Formula 17, and a combination thereof: 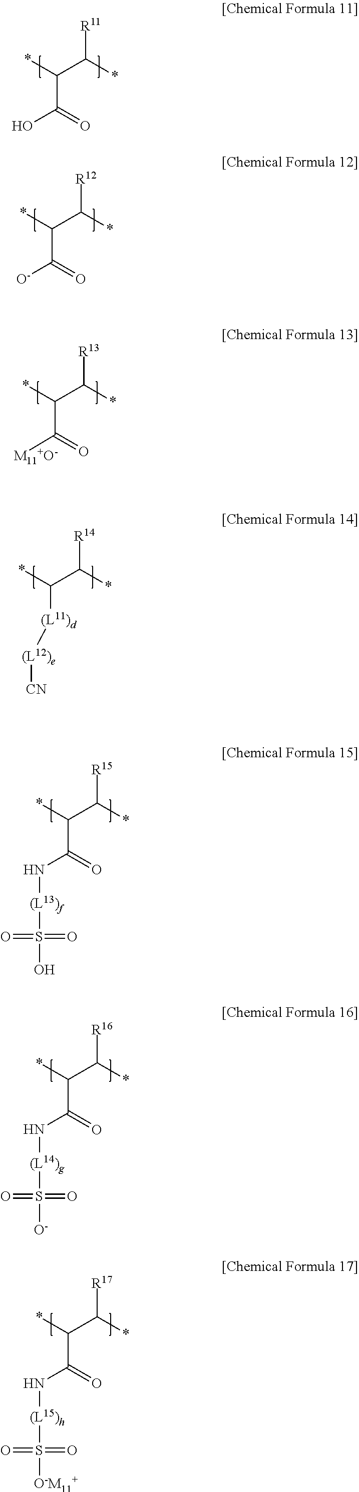
wherein, in Chemical Formulas 11 to 17,
R¹¹ to R¹⁷ are each independently hydrogen or C1 to C6 alkyl group;
L¹¹ and L¹² are each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
L¹³ to L¹⁵ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₁ is an alkali metal; and
d, e, f, g, and h are each independently an integer ranging from 0 to 2.

6. The rechargeable lithium battery as recited in claim 4, wherein
the seventh structural unit derived from (meth)acrylic acid or (meth)acrylate is represented by any one of Chemical Formula 101, Chemical Formula 102, Chemical Formula 103, and a combination thereof, and a structural unit derived from (meth)acrylamide is represented by Chemical Formula 104, and
the eighth structural unit is represented by any one of Chemical Formula 105, Chemical Formula 106, Chemical Formula 107, and a combination: 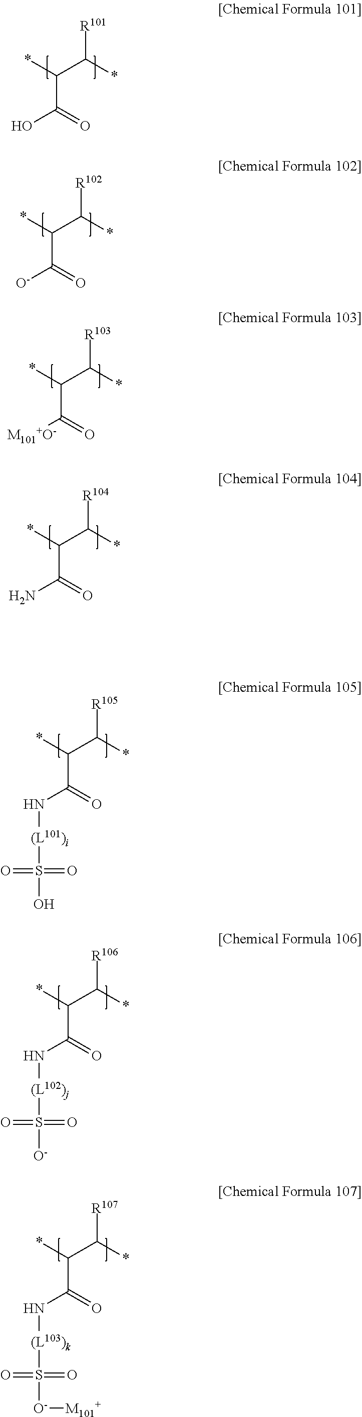
wherein, in Chemical Formulas 101 to 107,
R¹⁰¹ to R¹⁰⁷ are each independently hydrogen or C1 to C6 alkyl group;
L¹⁰¹ to L¹⁰³ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₀₁ is an alkali metal; and
i, j, and k are each independently an integer ranging from 0 to 2.

7. The rechargeable lithium battery as recited in claim 1, wherein the inorganic particles comprise at least one of Al₂O₃, SiO₂, TiO₂, SnO₂, CeO₂, MgO, NiO, CaO, GaO, ZnO, ZrO₂, Y₂O₃, SrTiOs, BaTiO₃, Mg(OH)₂, boehmite.

8. The rechargeable lithium battery as recited in claim 1, wherein a weight ratio of the swellable adhesive binder to the inorganic particles in the heat resistant adhesive layer is about 1:3 to about 1:30.

9. The rechargeable lithium battery as recited in claim 1, wherein a weight ratio of the heat resistant binder to the swellable adhesive binder in the heat resistant adhesive layer is about 1:1 to about 1:10.

10. The rechargeable lithium battery as recited in claim 1, wherein the heat resistant adhesive layer is located on both surfaces of the substrate.

11. The rechargeable lithium battery as recited in claim 1, wherein the heat resistant adhesive layer has a thickness of about 0.1 μm to about 5 μm.

12. The rechargeable lithium battery as recited in claim 1, wherein the substrate is a porous substrate.

13. The rechargeable lithium battery as recited in claim 12, wherein the porous substrate comprises a polyolefin-based porous substrate.

14. The rechargeable lithium battery as recited in claim 1, wherein the substrate has a thickness of about 1 μm to about 40 μm.

15. The rechargeable lithium battery as recited in claim 1, wherein
the heat resistant adhesive layer is located on both surfaces of the substrate, and
a loading amount of the swellable adhesive binder in contact with the negative electrode is higher than a loading amount of the swellable adhesive binder in contact with the positive electrode.

16. The rechargeable lithium battery as recited in claim 1, further comprising an electrolyte solution impregnated in the separator.

17. The rechargeable lithium battery as recited in claim 16, wherein the electrolyte solution comprises a lithium salt and a non-aqueous organic solvent.

18. The rechargeable lithium battery as recited in claim 1, wherein the positive electrode comprises a positive electrode active material represented by Chemical Formula I:
Liₐ₁Niₓ₁M¹_{y1}M²_{z1}O_{2-b1}X_{b1} [Chemical Formula I]
wherein, in Chemical Formula 1, 0.9≤a1≤1.2, 0.9≤x1≤1, 0≤y1≤0.1, 0≤z1≤0.1, 0.9≤x1+y1+z1≤1.1, and 0≤b1≤0.1;
M¹ and M² are each independently one or more element selected from Al, B, Ba, Ca, Ce, Co, Cr, Cu, Fe, Mg, Mn, Mo, Nb, Si, Sr, Ti, V, W, and Zr; and
X is one or more element selected from F, P, and S.

19. The rechargeable lithium battery as recited in claim 1, wherein the negative electrode comprises a negative electrode active material including at least one type of graphite and Si composite.

20. The rechargeable lithium battery as recited in claim 1, wherein the rechargeable lithium battery has an energy density of greater than or equal to about 700 Wh/L.
